(19) United States
(12) Patent Application Publication
(10) Pub. No.: US 2026/0311518 A1
(43) Pub. Date: Oct. 8, 2026

(54) LOTTERY TICKET STORAGE AND DISPENSING CASSETTE

(71) Applicant: IGT Global Solutions Corporation, Providence, RI (US)

(72) Inventors: Ramon Snow, West Greenwich, RI (US); Paul A. Bucci, Glocester, RI (US); Thomas Quaranta, North Kingstown, RI (US); Jérôme Froidevaux, Saignelégier (CH)

(21) Appl. No.: 19/171,870

(22) Filed: Apr. 7, 2025

(51) Int. Cl. G07B 3/02; G07F 17/32

(52) U.S. Cl. CPC G07B 3/02; G07F 17/329

(57) ABSTRACT

A cassette for storing a pack of lottery tickets, the cassette configured to be positioned in a lottery ticket dispenser, the cassette including a frame, a first side wall supported by the frame, a second side wall supported by the frame, a ticket guide assembly supported by the first side wall and the second side wall, the ticket guide assembly including a moveable roller assembly comprising a central shaft, a roller mounted on the central shaft, a first gear mounted on the central shaft, and a second gear mounted on the central shaft, a first biasing member connected the moveable roller assembly, and a second biasing member connected to the moveable roller assembly, and a ticket dispenser assembly supported by the frame.

### BACKGROUND

The present disclosure relates to a lottery-ticket storage and dispensing cassette for a lottery ticket dispenser.

Lottery ticket dispensers such as lottery ticket vending machines may include drawers that hold lottery tickets for dispensing.

### BRIEF SUMMARY

Various embodiments of the present disclosure relate to a cassette for storing and dispensing lottery tickets from a pack of lottery tickets. The cassette is configured to be positioned in a lottery ticket dispenser. The cassette includes: a frame; a first side wall supported by the frame; a second side wall supported by the frame; a ticket guide assembly supported by the first side wall and the second side wall, and a ticket dispenser assembly supported by the frame. The ticket guide assembly includes: a moveable roller assembly comprising a central shaft, a roller mounted on the central shaft, a first gear mounted on the central shaft, and a second gear mounted on the central shaft, a first biasing member connected to the moveable roller assembly, and a second biasing member connected to the moveable roller assembly.

Various other embodiments of the present disclosure relate to a cassette for storing and dispensing lottery tickets from a pack of lottery tickets. The cassette is configured to be positioned in a lottery ticket dispenser. The cassette includes: a frame comprising a bottom wall, a rear wall connected to and extending upwardly from the bottom wall, a first side support wall connected to and extending upwardly from the bottom wall, and a second side support wall connected to and extending upwardly from the bottom wall; a first side wall positioned in the frame adjacent to the first support wall; a second side wall positioned in the frame adjacent to the second support wall; a rear ticket engager positioned in the frame adjacent to the rear wall; a front wall supported by the fame; a ticket guide assembly supported by the first side wall and the second side wall; and a ticket dispenser assembly supported by the frame. The ticket guide assembly includes a moveable roller assembly comprising a central shaft, a roller mounted on the central shaft, a first gear mounted on the central shaft, and a second gear mounted on the central shaft, a first spring connected to the moveable roller assembly, and a second spring connected to the moveable roller assembly.

Various other embodiments of the present disclosure relate to a cassette for storing and dispensing lottery tickets from a pack of lottery tickets. The cassette is configured to be positioned in a lottery ticket dispenser. The cassette includes: a frame; a first side wall supported by the frame and comprising a first gear track; a second side wall supported by the frame and comprising a second gear track; a ticket guide assembly supported by the first side wall and the second side wall; and a ticket dispenser assembly supported by the frame. The ticket guide assembly includes: a moveable roller assembly comprising a central shaft, a roller mounted on the central shaft, a first gear mounted on the central shaft and movable on the first gear track, and a second gear mounted on the central shaft and movable on the second gear track, a first spring, a second spring, a first spring connector mounted on the central shaft such that the central shaft is rotatable with respect to the first spring connector, the first spring connector connected to the first spring, and a second spring connector mounted on the central shaft such that the central shaft is rotatable with respect to the second spring connector, the second spring connector connected to the second spring.

Additional features are described in, and will be apparent from, the following Detailed Description and the figures.

### BRIEF DESCRIPTION OF THE SEVERAL VIEWS OF THE DRAWINGS

FIG. 1 is a top perspective view a lottery ticket storage and dispensing cassette of one example embodiment of the present disclosure.

FIG. 2 is a top perspective view the lottery ticket storage and dispensing cassette of FIG. 1.

FIG. 3 is an exploded top perspective view of the lottery ticket storage and dispensing cassette of FIG. 1.

FIG. 4A is a first side view of the lottery ticket storage and dispensing cassette of FIG. 1.

FIG. 4B is a partial cross-sectional side view of the lottery ticket storage and dispensing cassette of FIG. 1.

FIG. 5A is a first front view of the lottery ticket storage and dispensing cassette of FIG. 1.

FIG. 5B is a second front view of the lottery ticket storage and dispensing cassette of FIG. 1 with the front panel of the front wall being transparent.

FIG. 5C is a third front view of the lottery ticket storage and dispensing cassette of FIG. 1 with the font panel wall thereof removed.

FIG. 6A to 6F are a series of top perspective views of the lottery ticket storage and dispensing cassette of FIG. 1 showing the operation thereof with respect to example instant lottery tickets of an example instant lottery ticket pack positioned therein and being dispensed therefrom.

### DETAILED DESCRIPTION

While the features, devices, and apparatus described herein may be embodied in various forms, the drawings show, and the specification describe certain exemplary and non-limiting embodiments. Not all the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, and the like, are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

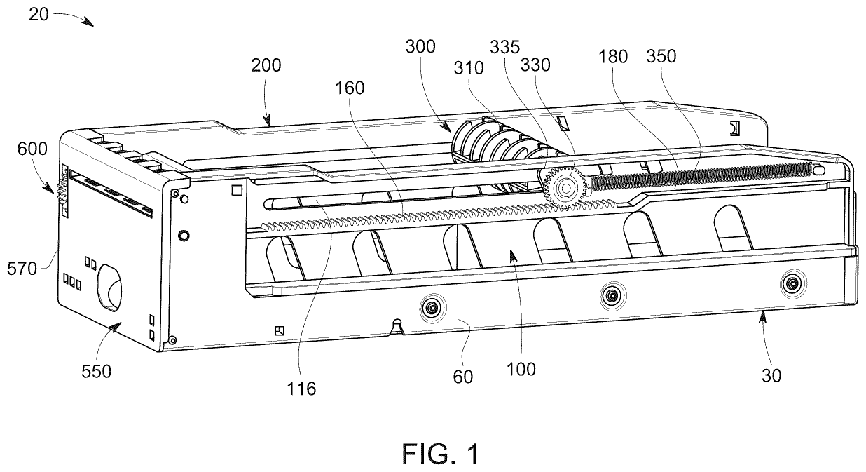

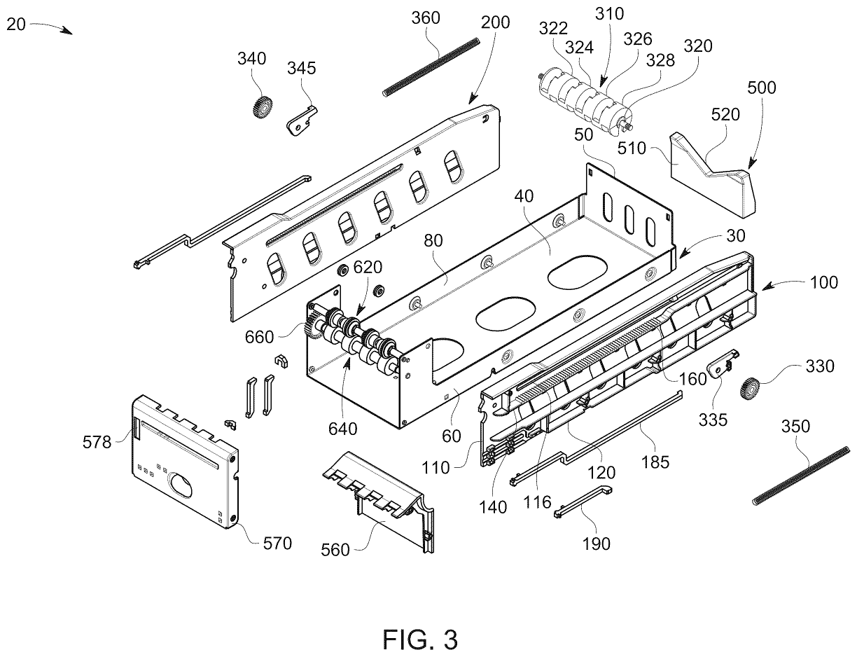

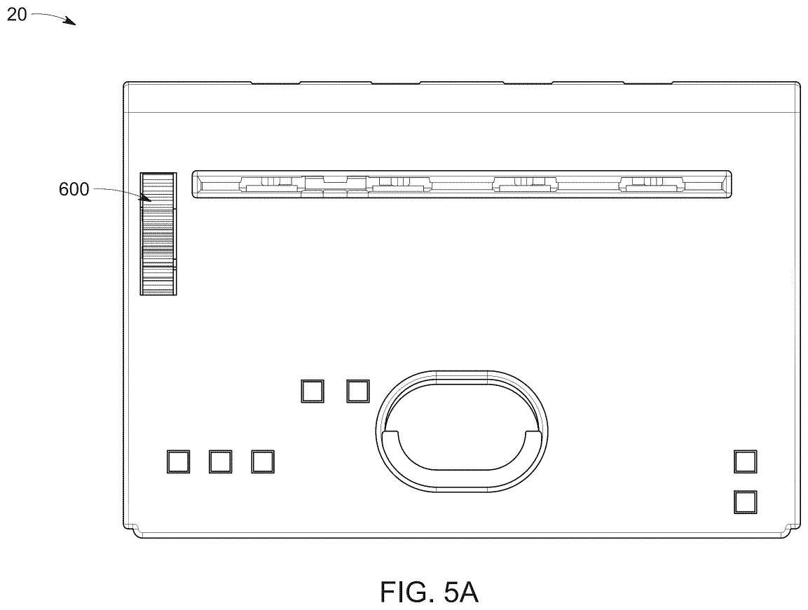

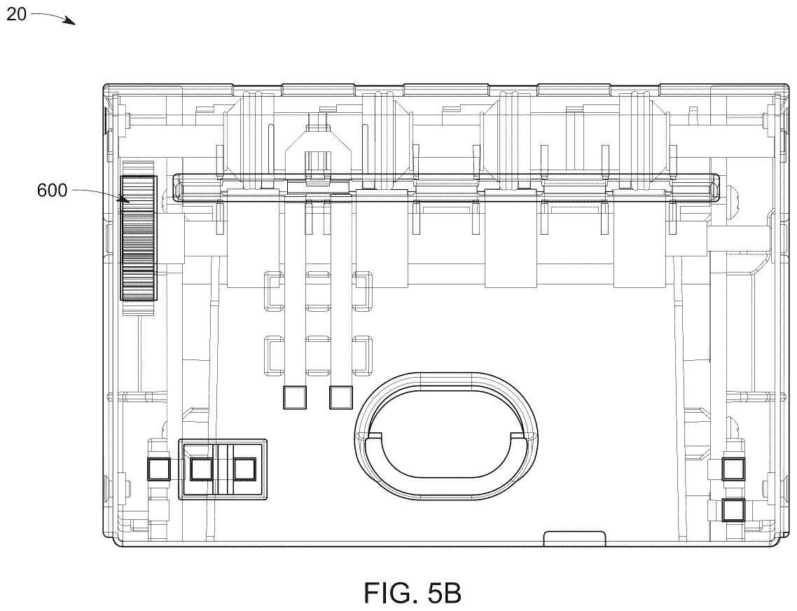

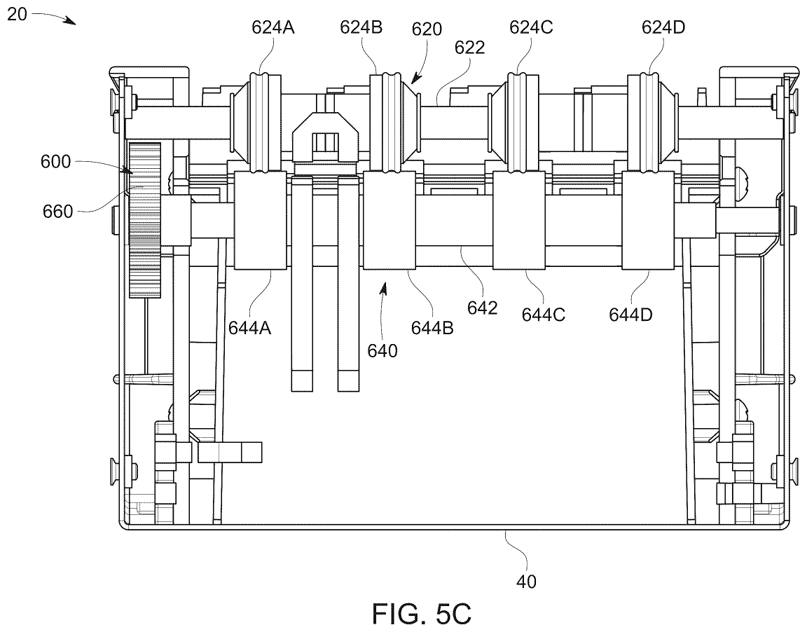

FIGS. 1 to 5C illustrate a lottery ticket storage and dispensing cassette 20 of one example embodiment of the present disclosure. The present disclosure also relates to a lottery ticket dispenser including one or more of these lottery ticket storage and dispensing cassettes 20.

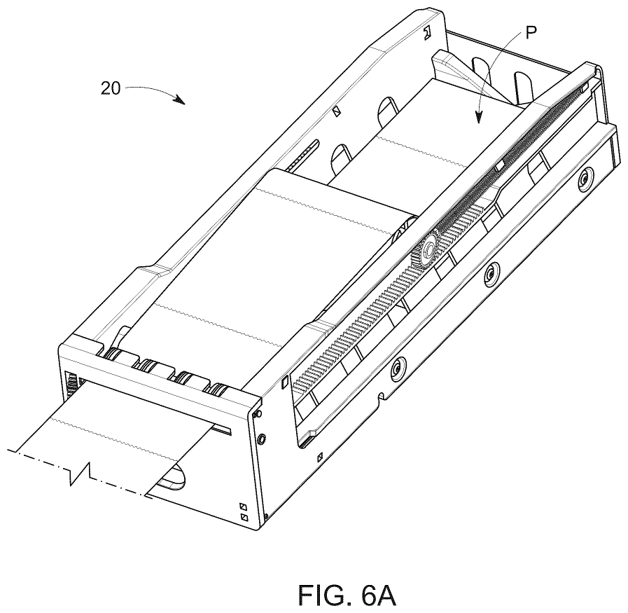

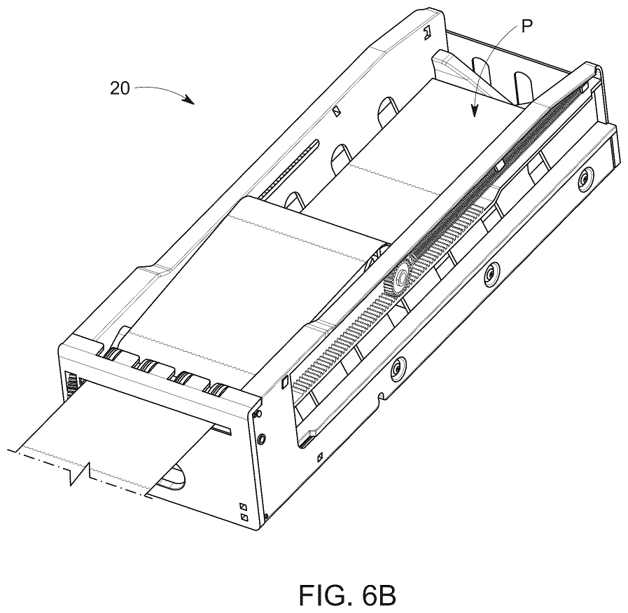

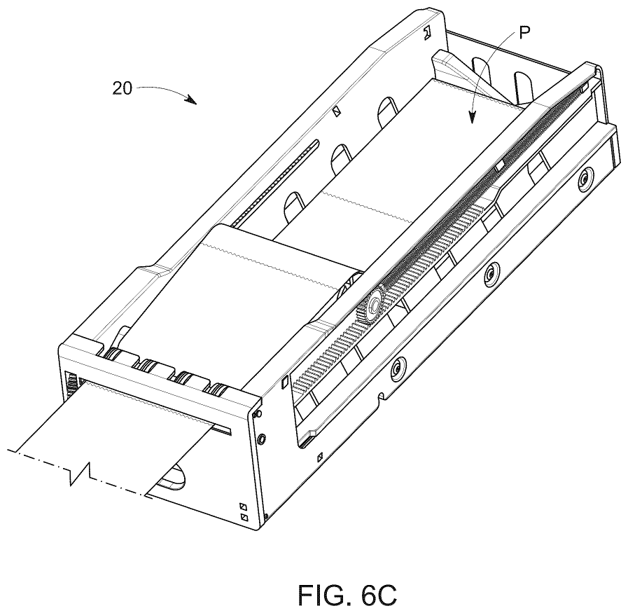

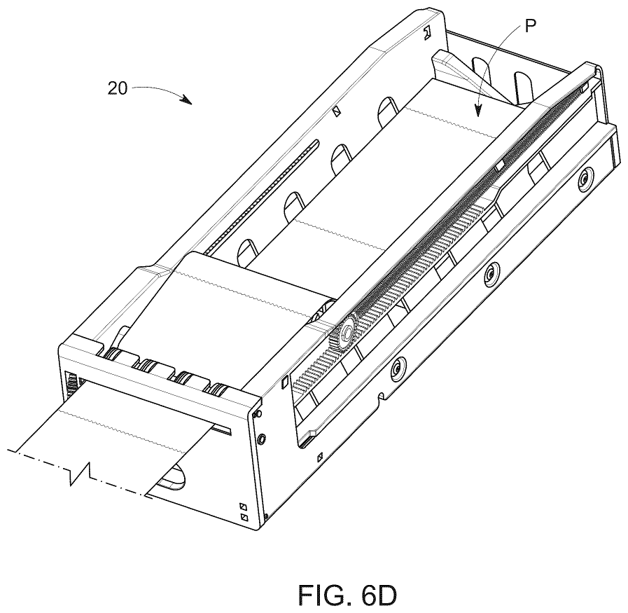

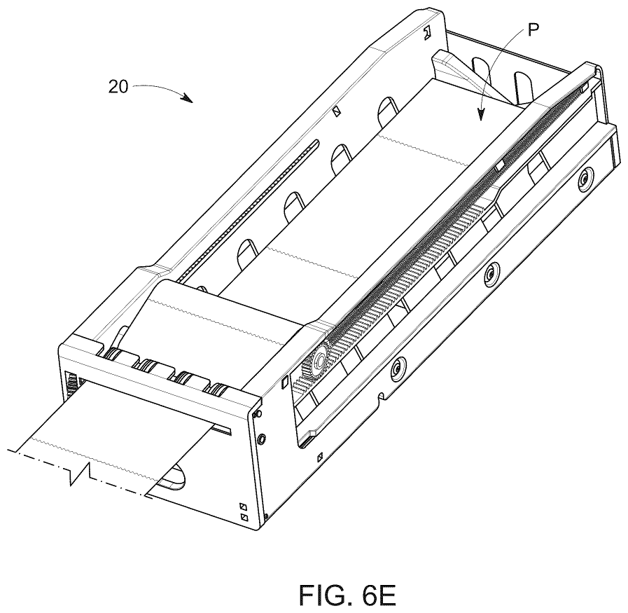

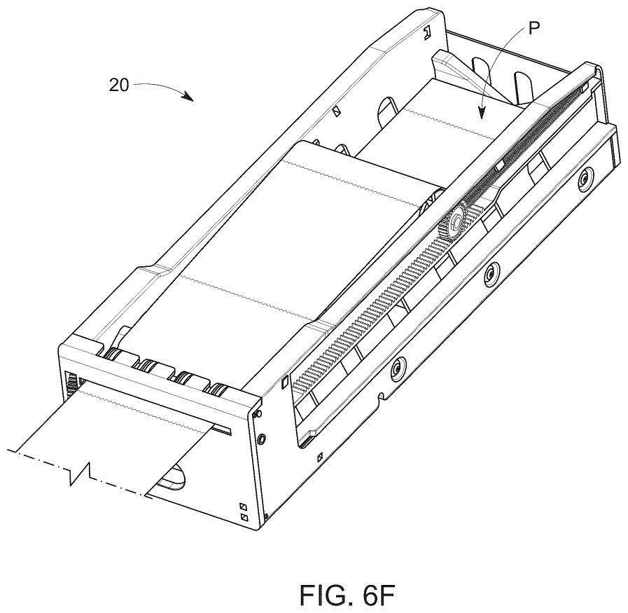

FIGS. 6A to 6F illustrate the operation of the lottery ticket storage and dispensing cassette 20 with respect to an example pack of example instant lottery tickets positioned therein and being dispensed therefrom. The present disclosure also relates to a method of operating the lottery ticket storage and dispensing cassettes 20. It should be appreciated that the method can vary based on the length of the instant lottery tickets.

The lottery ticket storage and dispensing cassette 20 is referred to as the cassette 20 for brevity.

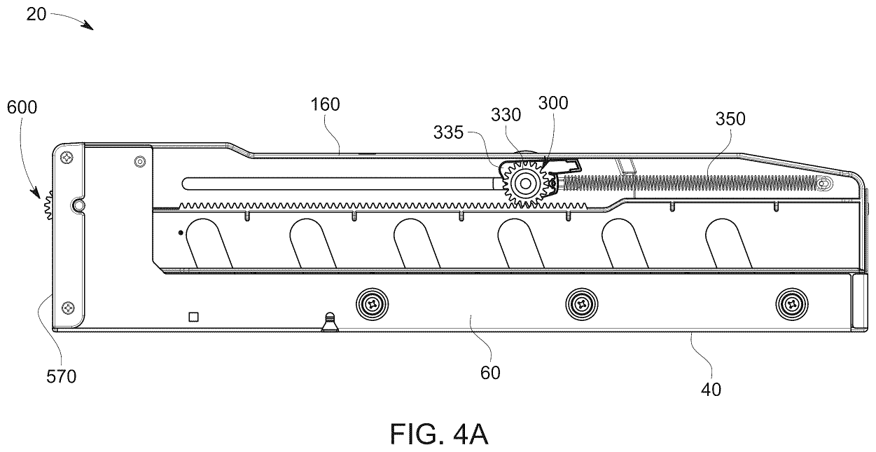

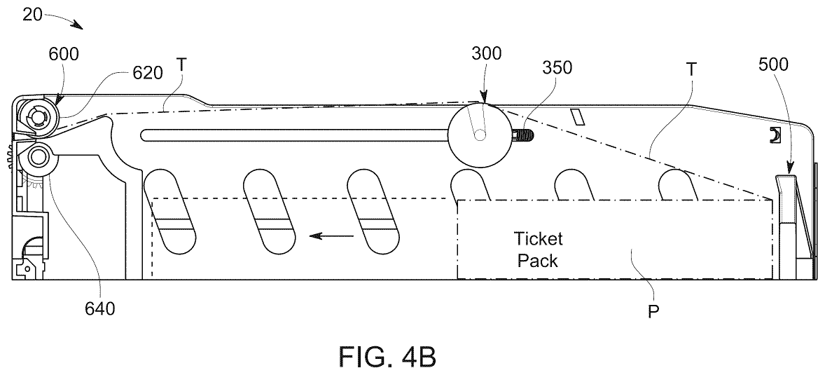

The cassette 20 is configured to receive, store, and dispense lottery tickets T from a lottery ticket pack P (that includes a plurality of lottery tickets that are fan folded and positioned in the cassette 20 such as shown in FIGS. 4B and 6A to 6F). Each adjacent pair of lottery tickets T in the pack P are joined along a perforation and form a strip of lottery tickets T that has regularly spaced folds along the perforations. The cassette 20 is configured to receive, store, and dispense these lottery tickets T from the pack P, where the lottery tickets and the pack dimensions can vary. The cassette 20 is configured to be employed in a lottery ticket dispenser such as a lottery ticket vending machine.

The cassette 20 includes: (1) a frame 30; (2) a first side wall 100 supported by and connected to the frame 30; (3) a second side wall 200 supported by and connected to the frame 30; (4) a ticket guide assembly 300 supported and connected to the first side wall 100 and the second side wall 200; (5) a rear ticket engager 500 supported by the frame 30; (6) a front wall 550 supported by the frame 30; and (7) a ticket dispenser assembly 600 supported by the frame 30.

More specifically, the frame 30 includes a bottom wall 40, a rear wall 50 connected to and extending upwardly from the bottom wall 40, a first side support wall 60 connected to and extending upwardly from the bottom wall 40, and a second side support wall 80 connected to and extending upwardly from the bottom wall 40.

The first side wall 100 includes an inner panel 110, a lower section 120 connected to and extending transversely from the outer surface (not labelled) of the inner panel 110, and an upper section 140 connected to and extending transversely from the outer surface of the inner panel 110 and above the lower section 120. The first side wall 100 is configured to be positioned in the frame 30 on the bottom wall 40 and inside of, adjacent to, and connected to the first side support wall 60.

The panel 110 includes inner edges (not labelled) that define a plurality of openings (not labelled) configured to receive fasteners (not labelled) that connect the first side wall 100 to the first side support wall 60 of the frame 30.

The panel 110 includes an inner elongated oval edge (not labelled) that defines an elongated shaft receiving opening 116 configured to receive part of the central shaft 320 of the roller assembly 310 (described below), to allow that central shaft 320 to move forwardly and rearwardly in the oval opening 116, and to limit the forward and rearward movements of the central shaft 320 and thus the roller assembly 310.

The lower section 120 includes a plurality members (not individually labelled) connected to and extending transversely from the outer surface (not labelled) of the inner panel 110. These members provide structural support for the panel 110 and the entire first side wall 100.

The upper section 140 includes a plurality members (not individually labelled) connected to and extending transversely from the outer surface of the inner panel 110. These members provide structural support for the panel 110 and the entire first side wall 100.

These members of the upper section 140 also define a gear track 160 configured to mate with and engage and support the first gear 330 of the roller assembly 310 (described below), to enable that first gear 330 to move forwardly and rearwardly on the gear track 160, and to limit the forward and rearward movements of the first gear 330 and thus the roller assembly 310. The gear track 160 extends below the shaft receiving opening 116 of the panel 110.

These members of the upper section 140 also define a spring receipt area 180 configured to receive the first spring 350 of the roller assembly 310 (described below) to control the forward and rearward movements of the first gear 330 and thus the roller assembly 310.

The first side wall 100 includes light pipes 185 and 190 that can be employed for infrared sensors that can be used to determine the quantity of tickets in the cassette.

The second side wall 200 includes the same parts as the first side wall 100 in mirror image form and are thus not all shown or described herein for brevity. The second side wall 200 is configured to be positioned in the frame 30 on the bottom wall 40 and inside of, adjacent to, and connected to the second side support wall 80.

The ticket guide assembly 300 includes a moveable roller assembly 310, a first biasing member and particularly spring 350 connected the moveable roller assembly 310, and a second biasing member and particularly a spring 360 connected to the moveable roller assembly 310.

The movable roller assembly 310 includes a rotatable central shaft 320. The central shaft 320 includes a central section (not labelled), a first end (not labelled), and a second end (not labelled). The central section extends between the first and second side walls 100 and 200 and is moveable forwardly and rearwardly between the first and second side walls 100 and 200. The first end extends through the opening 116 in the first side wall 100 and is moveable forwardly and rearwardly in that opening. The second end extends through the corresponding opening in the second side wall 200 and is moveable forwardly and rearwardly in that opening.

The movable roller assembly 310 further includes a roller with a plurality of semi-cylindrical roller segments such as segments 322, 324, 326, and 328 rotatably mounted on the central shaft 320, a first gear 330 fixedly connected to a first end of the central shaft 320, a second gear 340 fixedly connected to a second end of the central shaft 320, a first spring connector 335 mounted on the first end of the central shaft 320 (such that the central shaft can rotate relative to the first spring connector 335), and a second spring connector 345 mounted on the central shaft 320 (such that the central shaft can rotate relative to the second spring connector 345). In various embodiments, the roller can include two or more rollers.

The roller including the plurality of cylindrical roller segments is mounted on the central shaft 320 and freely rotatable on the central shaft 320. The plurality of cylindrical rollers 322, 324, 326, and 328 are configured to engage the lottery tickets during the storage, movement, and dispensing of the lottery tickets such as shown in FIG. 6A to 6F and as further described below.

The first gear 330 is fixedly connected to the first end of the central shaft 320 and is configured to mate with and engage the first gear track 160 and to move along that gear track 160. The first gear 330 is configured to rotate on the first gear track defined by the first side wall 100.

The second gear 340 is fixedly connected to the second end of the central shaft 320 and is configured to mate with and engage the second gear track of the second side wall 200 and to move along that gear track. The second gear 330 is configured to rotate on the second gear track defined by second side wall 200.

Thus, the central shaft 320, the first gear 330, and the second gear 340 are connected and configured such that they move in unison. The combination of the first and second gears and their interactions with the gear racks ensure the shaft stays parallel in the cassette 20 and this preventing it from angling in the cassette 20 which could cause a jamming or sticking of the shaft and rollers.

The first spring connector 335 is mounted on the first end of the central shaft 320 such that the central shaft is rotatable with respect to the first spring connector 335. The first spring connector 335 is connected to the first spring 350 such that the first spring 350 biases the first spring connector 335 rearwardly, and thus the central shaft 320 rearwardly and the plurality of cylindrical rollers 322, 324, 326, and 328 rearwardly.

The second spring connector 345 is mounted on the second end of the central shaft 320 such that the central shaft is rotatable with respect to the second spring connector 345. The second spring connector 345 is connected to the second spring 360 such that the second spring 360 biases the second spring connector 345 rearwardly, and thus the central shaft 320 rearwardly and thus the plurality of cylindrical rollers 322, 324, 326.

The first spring 350 is a coil spring and is positioned in the spring receipt area 180 of the first wall 100. The first spring 350 is connected at a forward end to the first spring connector 335 and at a rear end to a spring mount (not labelled) of the first side wall 100. The first spring 350 is configured to apply the rearward bias to the first spring connector 335, the central shaft 320, the first gear 330, and the plurality of cylindrical rollers 322, 324, 326, and 328.

The second spring 360 is a coil spring and is positioned in the spring receipt area of the second wall 200. The second spring 360 is connected at a forward end to the second spring connector 345 and at a rear end to a spring mount of the second side wall 200. The second spring 360 is configured to apply the rearward bias to the second spring connector 345, the central shaft 320, the second gear 340, and the plurality of cylindrical rollers 322, 324, 326, and 328.

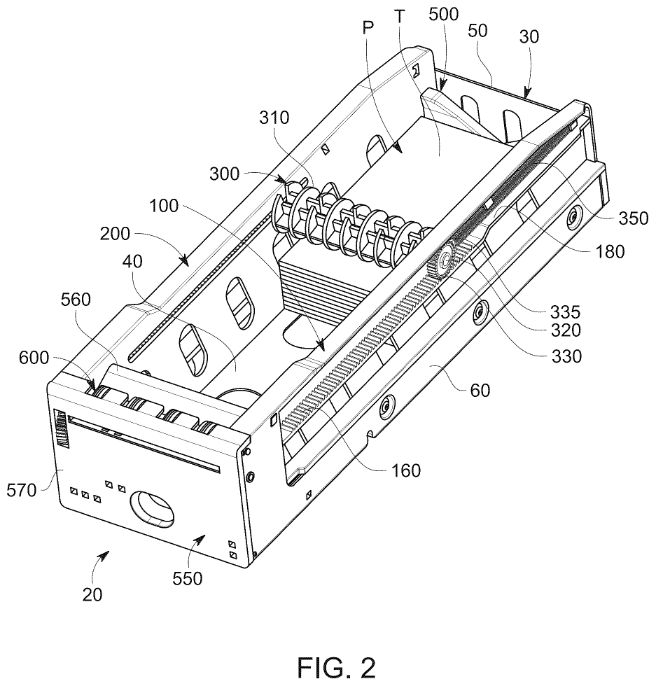

In this example embodiments, the rear ticket engager 500 is positioned adjacent to the rear wall 50 and includes a front wall 510 that is configured to engage a rear end of the ticket pack P such as shown in FIGS. 2 and 4B. In this example embodiment, the rear ticket engager 500 defines a ticket access notch 520 that is V-shaped in this illustrated embodiment to enable a finger of an operator to access and engage the rear end of a ticket pack P in the cassette 20 to facilitate removal of the ticket pack P from the cassette 20 if needed. In one embodiment, the rear ticket engager 500 can be magnetically attached to the bottom wall of the frame and can be repositioned in the cassette to hold the back of the ticket pack in place. This restricts the movement of problematic ticket packs and increases their dispensability. The rear ticket engager 500 can be otherwise repositionable in the frame. In other embodiments, the rear ticket engager can be otherwise shaped, sized, positioned, and otherwise configured. In other embodiments, the cassette does not include such a rear ticket engager.

The front wall 550 includes an inner panel 560 and an outer panel 570 that enclose part of the ticket dispenser assembly 600. The inner panel 560 and the outer panel 570 are connected to each other around part of the ticket dispenser assembly 600. The inner panel 560 partially defines the inner ticket pack receipt and movement area of the cassette 20. The outer panel 570 protects part of the ticket dispenser assembly 600 and includes an inner edge (not labelled) that defines an activation gear receipt opening 578 through which part of the activation gear 660 of the ticket dispenser assembly 600 extends. The inner panel 560 and the outer panel 570 define aligned ticket receipt openings (not labelled) through which tickets move as they are pulled from the cassette 20. The inner panel 560 and the outer panel 570 thus partially function as guides for the tickets to move out of the cassette. The outer panel 570 also provides the ability for the sensors on the burster to interact with the internals components of the cassette 20.

The ticket dispenser assembly 600 includes an upper ticket engager 620, a lower ticket engager 640, and an activation gear 660.

The upper ticket engager 620 includes a rotatable central shaft 622. The central shaft 622 includes a central section (not labelled), a first end (not labelled), and a second end (not labelled). The first end is rotatably supported by an upper portion of first side support wall 60 of the frame 30. The second end is freely rotatably supported by an upper portion of second side support wall 80 of the frame 30. The central section extends between the upper portion of first side support wall 60 of the frame 30 and the upper portion of second side support wall 80 of the frame 30. The upper ticket engager 620 further includes a plurality of rollers 624a, 624b, 624c, and 624d rotatably mounted on the central shaft 622 and configured to engage a top surface of each ticket as that ticket moves through the panels of the front wall 550.

The lower ticket engager 640 includes a rotatable central shaft 642. The central shaft 642 includes a central section (not labelled), a first end (not labelled), and a second end (not labelled). The first end is rotatably supported by an upper portion of first side support wall 60 of the frame 30. The second end is freely rotatably supported by an upper portion of second side support wall 80 of the frame 30. The central section extends between the upper portion of first side support wall 60 of the frame 30 and the upper portion of second side support wall 80 of the frame 30. The lower ticket engager 640 further includes a plurality of rollers 644a, 644b, 644c, and 644d fixedly mounted on the central shaft 642 and configured to engage a bottom surface of each ticket. The lower ticket engager 640 also functions to move the tickets through the panels of the front wall 550 and through the space (not labelled) between the upper ticket engager 620 and the lower ticket engager 640. The rollers of the lower ticket engager 640 are fixedly connected together on the shaft 642. The rollers are rubber over-molded onto the shaft and the gear is press fitted. This causes the shaft, center roller, and gear all rotate together.

The activation gear 660 is fixedly connected to the central shaft 642 of the lower ticket engager 640 and is configured to cause the rotation of that central shaft 642 and the plurality of rollers 644a, 644b, 644c, and 644d mounted on the central shaft 642.

The activation gear 660 is configured to be engaged by a drive gear (not shown) of a ticket burster (not shown) of the lottery ticket dispenser (not shown) in which the cassette 20 is positioned. Rotation of the activation gear 660 by the drive gear is a first direction causes the lower ticket engager 640 to rotate in that same first direction and causes the lower ticket engager 640 to pull the ticket between the lower ticket engager 640 and the upper ticket engager 620 out of the cassette 20. Rotation of the activation gear 660 by the drive gear is an opposite second direction causes the lower ticket engager 640 to rotate in that same second direction and causes the lower ticket engager 640 to pull the ticket between the lower ticket engager 640 and the upper ticket engager 620 back into the cassette 20.

FIGS. 6A to 6F partially show the movements of certain of the above-described components as the lottery tickets are pulled from the pack in the cassette 20 by a ticket burster (not shown) engaging the cassette 20 and specifically by a drive gear (not shown) of the ticket burster engaging and rotating the activation gear 660 in the first direction.

It should be appreciated that when an operator loads a pack in the cassette 20, the operator will need to position the first ticket of that pack over the rollers of the roller assembly 300 and between the lower ticket engager 640 and the upper ticket engager 620 of the cassette 20.

It should be appreciated that the movements of the roller assembly 300 is shown certain example tickets of the pack that engage the roller assembly and that for other instant tickets of the pack that are pulled from the cassette 20, the roller assembly 300 can stay in the position shown in FIG. 6F such that such instant tickets simply slide over the roller assembly 200 without causing such movement against the springs.

FIG. 6A shows the tickets of the pack P being pulled out of the cassette 20 between the lower ticket engager 640 and the upper ticket engager 620 of the cassette 20. FIG. 6A also shows that one of the tickets of the pack P has engaged the rollers 322, 324, 326, and 328 of the roller assembly 300 and caused the forward movement of the rollers 322, 324, 326, and 328, the central shaft 320, the spring connectors 335 and 345, and the gears 330 and 340, all against the biasing of the springs 350 and 360.

FIG. 6B shows the tickets of the pack P being further pulled out of the cassette 20 between the lower ticket engager 640 and the upper ticket engager 620 of the cassette 20. FIG. 6B also shows that one of the tickets of the pack P engages the rollers 322, 324, 326, and 328 of the roller assembly 300 and has caused the further forward movement of the rollers 322, 324, 326, and 328, the central shaft 320, the spring connectors 335 and 345, and the gears 330 and 340, all against the biasing of the springs 330 and 360.

FIG. 6C shows the tickets of the pack P being further pulled out of the cassette 20 between the lower ticket engager 640 and the upper ticket engager 620 of the cassette 20. FIG. 6C also shows that one of the tickets of the pack P engages the rollers 322, 324, 326, and 328 of the roller assembly 300 and has caused the further forward movement of the rollers 322, 324, 326, and 328, the central shaft 320, the spring connectors 335 and 345, and the gears 330 and 340, all against the biasing of the springs 330 and 360.

FIG. 6D shows the tickets of the pack P being further pulled out of the cassette 20 between the lower ticket engager 640 and the upper ticket engager 620 of the cassette 20. FIG. 6D also shows that one of the tickets of the pack P engages the rollers 322, 324, 326, and 328 of the roller assembly 300 and has caused the further forward movement of the rollers 322, 324, 326, and 328, the central shaft 320, the spring connectors 335 and 345, and the gears 330 and 340, all against the biasing of the springs 330 and 360.

FIG. 6E shows the tickets of the pack P being further pulled out of the cassette 20 between the lower ticket engager 640 and the upper ticket engager 620 of the cassette 20. FIG. 6E also shows that one of the tickets of the pack P engages the rollers 322, 324, 326, and 328 of the roller assembly 300 and has caused the further forward movement of the rollers 322, 324, 326, and 328, the central shaft 320, the spring connectors 335 and 345, and the gears 330 and 340, all against the biasing of the springs 330 and 360.

FIG. 6F shows that after dispensing one or more tickets of the pack P, the rollers 322, 324, 326, and 328, the central shaft 320, the spring connectors 335 and 345, and the gears 330 and 340 are all biased by the springs 330 and 360 back to their resting positions.

The operation of the roller assembly in the cassette provides a ticket path that enables the tickets to unfold and separate as it gets to the ticket exit and keeps the ticket justified so that they can be dispensed with a high success rate.

It should be appreciated that the movement of the roller assembly in the cassette can depend on the length of each of the tickets of ticket pack that is positioned in the cassette, and that the roller assembly is configured to function with different length tickets.

It should be appreciated from the above that various embodiments of the present disclosure provide a cassette for storing and dispensing lottery tickets from a pack of lottery tickets, the cassette configured to be positioned in a lottery ticket dispenser, the cassette comprising: (1) a frame; (2) a first side wall supported by the frame; (3) a second side wall supported by the frame; (4) a ticket guide assembly supported by the first side wall and the second side wall, the ticket guide assembly comprising: (a) a moveable roller assembly comprising a central shaft, a roller mounted on the central shaft, a first gear mounted on the central shaft, and a second gear mounted on the central shaft, (b) a first biasing member connected to the moveable roller assembly, and (c) a second biasing member connected to the moveable roller assembly; and (4) a ticket dispenser assembly supported by the frame. In various embodiments, the first side wall comprises a first gear track supporting the first gear and enabling the first gear to move forwardly and rearwardly on the first gear track, and wherein the second side wall comprises a second gear track supporting the second gear and enabling the second gear to move forwardly and rearwardly on the second gear track. In various embodiments, the first side wall limits forward and rearward movements of the first gear and the second side wall limits forward and rearward movements of the second gear. In various embodiments, each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft. In various embodiments, the first biasing member comprises a first coil spring and the second biasing member comprises a second coil spring. In various embodiments, the moveable roller assembly comprises: (a) a first spring connector mounted on the central shaft such that the central shaft is rotatable with respect to the first spring connector, the first spring connector connected to the first coil spring such that the first coil spring biases the first spring connector rearwardly, and thus the central shaft rearwardly; and (b) a second spring connector mounted on the central shaft such that the central shaft is rotatable with respect to the second spring connector, the second spring connector connected to the second coil spring such that the second coil spring biases the second spring connector rearwardly, and thus the central shaft rearwardly. In various embodiments, each of the first side wall and the second side wall defines a spring receipt area. In various embodiments, the movable roller assembly comprises a single roller rotatably mounted on the central shaft. In various embodiments, the cassette comprises a rear ticket engager positioned in and supported by the frame. In various embodiments, the cassette comprises a front wall supported by the frame and enclosing part of the ticket dispenser assembly. In various embodiments, the frame comprises a bottom wall, a rear wall connected to and extending upwardly from the bottom wall, a first side support wall connected to and extending upwardly from the bottom wall, and a second side support wall connected to and extending upwardly from the bottom wall.

It should be appreciated from the above that various embodiments of the present disclosure provide a cassette for storing and dispensing lottery tickets from a pack of lottery tickets, the cassette configured to be positioned in a lottery ticket dispenser, the cassette comprising: (1) a frame comprising a bottom wall, a rear wall connected to and extending upwardly from the bottom wall, a first side support wall connected to and extending upwardly from the bottom wall, and a second side support wall connected to and extending upwardly from the bottom wall; (2) a first side wall positioned in the frame adjacent to the first support wall; (3) a second side wall positioned in the frame adjacent to the second support wall; (4) a rear ticket engager positioned in the frame adjacent to the rear wall; (5) a front wall supported by the fame; (6) a ticket guide assembly supported by the first side wall and the second side wall, the ticket guide assembly comprising: (a) a moveable roller assembly comprising a central shaft, a roller mounted on the central shaft, a first gear mounted on the central shaft, and a second gear mounted on the central shaft, (b) a first spring connected to the moveable roller assembly, and (c) a second spring connected to the moveable roller assembly; and (7) a ticket dispenser assembly supported by the frame. In various embodiments, the first side wall comprises a first gear track supporting the first gear and enabling the first gear to move forwardly and rearwardly on the first gear track, and wherein the second side wall comprises a second gear track supporting the second gear and enabling the second gear to move forwardly and rearwardly on the second gear track. In various embodiments, the first side wall limits forward and rearward movements of the first gear and the second side wall limits forward and rearward movements of the second gear. In various embodiments, each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft. In various embodiments, the moveable roller assembly comprises: (a) a first spring connector mounted on the central shaft such that the central shaft is rotatable with respect to the first spring connector, the first spring connector connected to the first spring such that the first spring biases the first spring connector rearwardly, and thus the central shaft rearwardly; and (b) a second spring connector mounted on the central shaft such that the central shaft is rotatable with respect to the second spring connector, the second spring connector connected to the second spring such that the second spring biases the second spring connector rearwardly, and thus the central shaft rearwardly.

It should be appreciated from the above that various embodiments of the present disclosure provide a cassette for storing and dispensing lottery tickets from a pack of lottery tickets, the cassette configured to be positioned in a lottery ticket dispenser, the cassette comprising: (1) a frame; (2) a first side wall supported by the frame and comprising a first gear track; (3) a second side wall supported by the frame and comprising a second gear track; (4) a ticket guide assembly supported by the first side wall and the second side wall, the ticket guide assembly comprising: (a) a moveable roller assembly comprising a central shaft, a roller mounted on the central shaft, a first gear mounted on the central shaft and movable on the first gear track, and a second gear mounted on the central shaft and movable on the second gear track, (b) a first spring, (c) a second spring, (d) a first spring connector mounted on the central shaft such that the central shaft is rotatable with respect to the first spring connector, the first spring connector connected to the first spring, and (e) a second spring connector mounted on the central shaft such that the central shaft is rotatable with respect to the second spring connector, the second spring connector connected to the second spring; and (5) a ticket dispenser assembly supported by the frame. In various embodiments, the first side wall limits forward and rearward movements of the first gear and the second side wall limits forward and rearward movements of the second gear. In various embodiments, each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft. In various embodiments, the cassette comprises a rear ticket engager positioned in and supported by the frame.

The various embodiments described here are not intended to be mutually exclusive. They may be considered individually or in combination with one another. Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

What is claimed is:

1. A cassette for storing and dispensing lottery tickets from a pack of lottery tickets, the cassette configured to be positioned in a lottery ticket dispenser, the cassette comprising:
a frame;
a first side wall supported by the frame;
a second side wall supported by the frame;
a ticket guide assembly supported by the first side wall and the second side wall, the ticket guide assembly comprising:
a moveable roller assembly comprising a central shaft, a roller mounted on the central shaft, a first gear mounted on the central shaft, and a second gear mounted on the central shaft,
a first biasing member connected to the moveable roller assembly, and
second biasing member connected to the moveable roller assembly; and
a ticket dispenser assembly supported by the frame.

2. The cassette of claim 1, wherein the first side wall comprises a first gear track supporting the first gear and enabling the first gear to move forwardly and rearwardly on the first gear track, and wherein the second side wall comprises a second gear track supporting the second gear and enabling the second gear to move forwardly and rearwardly on the second gear track.

3. The cassette of claim 2, wherein the first side wall limits forward and rearward movements of the first gear and the second side wall limits forward and rearward movements of the second gear.

4. The cassette of claim 1, wherein each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft.

5. The cassette of claim 1, wherein the first biasing member comprises a first coil spring and the second biasing member comprises a second coil spring.

6. The cassette of claim 5, wherein the moveable roller assembly comprises:
a first spring connector mounted on the central shaft such that the central shaft is rotatable with respect to the first spring connector, the first spring connector connected to the first coil spring such that the first coil spring biases the first spring connector rearwardly, and thus the central shaft rearwardly; and
a second spring connector mounted on the central shaft such that the central shaft is rotatable with respect to the second spring connector, the second spring connector connected to the second coil spring such that the second coil spring biases the second spring connector rearwardly, and thus the central shaft rearwardly.

7. The cassette of claim 1, wherein each of the first side wall and the second side wall defines a spring receipt area.

8. The cassette of claim 7, wherein the movable roller assembly comprises a single roller rotatably mounted on the central shaft.

9. The cassette of claim 1, which comprises a rear ticket engager positioned in and supported by the frame.

10. The cassette of claim 1, which comprises a front wall supported by the frame and enclosing part of the ticket dispenser assembly.

11. The cassette of claim 1, wherein the frame comprises a bottom wall, a rear wall connected to and extending upwardly from the bottom wall, a first side support wall connected to and extending upwardly from the bottom wall, and a second side support wall connected to and extending upwardly from the bottom wall.

12. A cassette for storing and dispensing lottery tickets from a pack of lottery tickets, the cassette configured to be positioned in a lottery ticket dispenser, the cassette comprising:
a frame comprising a bottom wall, a rear wall connected to and extending upwardly from the bottom wall, a first side support wall connected to and extending upwardly from the bottom wall, and a second side support wall connected to and extending upwardly from the bottom wall;
a first side wall positioned in the frame adjacent to the first support wall;
a second side wall positioned in the frame adjacent to the second support wall;
a rear ticket engager positioned in the frame adjacent to the rear wall;
a front wall supported by the fame;
a ticket guide assembly supported by the first side wall and the second side wall, the ticket guide assembly comprising:
a moveable roller assembly comprising a central shaft, a roller mounted on the central shaft, a first gear mounted on the central shaft, and a second gear mounted on the central shaft,
a first spring connected to the moveable roller assembly, and
a second spring connected to the moveable roller assembly; and
a ticket dispenser assembly supported by the frame.

13. The cassette of claim 12, wherein the first side wall comprises a first gear track supporting the first gear and enabling the first gear to move forwardly and rearwardly on the first gear track, and wherein the second side wall comprises a second gear track supporting the second gear and enabling the second gear to move forwardly and rearwardly on the second gear track.

14. The cassette of claim 13, wherein the first side wall limits forward and rearward movements of the first gear and the second side wall limits forward and rearward movements of the second gear.

15. The cassette of claim 12, wherein each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft.

16. The cassette of claim 12, wherein the moveable roller assembly comprises:
a first spring connector mounted on the central shaft such that the central shaft is rotatable with respect to the first spring connector, the first spring connector connected to the first spring such that the first spring biases the first spring connector rearwardly, and thus the central shaft rearwardly; and
a second spring connector mounted on the central shaft such that the central shaft is rotatable with respect to the second spring connector, the second spring connector connected to the second spring such that the second spring biases the second spring connector rearwardly, and thus the central shaft rearwardly.

17. A cassette for storing and dispensing lottery tickets from a pack of lottery tickets, the cassette configured to be positioned in a lottery ticket dispenser, the cassette comprising:
a frame;
a first side wall supported by the frame and comprising a first gear track;
a second side wall supported by the frame and comprising a second gear track;
a ticket guide assembly supported by the first side wall and the second side wall, the ticket guide assembly comprising:
a moveable roller assembly comprising a central shaft, a roller mounted on the central shaft, a first gear mounted on the central shaft and movable on the first gear track, and a second gear mounted on the central shaft and movable on the second gear track,
a first spring,
a second spring,
a first spring connector mounted on the central shaft such that the central shaft is rotatable with respect to the first spring connector, the first spring connector connected to the first spring, and
a second spring connector mounted on the central shaft such that the central shaft is rotatable with respect to the second spring connector, the second spring connector connected to the second spring; and
a ticket dispenser assembly supported by the frame.

18. The cassette of claim 17, wherein the first side wall limits forward and rearward movements of the first gear and the second side wall limits forward and rearward movements of the second gear.

19. The cassette of claim 17, wherein each of the first side wall and the second side wall is positioned in the frame and comprises an inner elongated edge that defines an elongated shaft receiving opening configured to receive part of the central shaft of the roller assembly to allow that central shaft to move forwardly and rearwardly in the opening and to limit the forward and rearward movements of the central shaft.

20. The cassette of claim 17, which comprises a rear ticket engager positioned in and supported by the frame.
